(19) United States
(12) Patent Application Publication
(10) Pub. No.: US 2013/0008075 A1
(43) Pub. Date: Jan. 10, 2013

(54) Quick release fishing weight

(76) Inventor: John Richard Lindeman, Milwaukee, WI (US)

(21) Appl. No.: 13/135,533

(22) Filed: Jul. 8, 2011

(51) Int. Cl. A01K 95/02

(52) U.S. Cl. 43/43.12

(57) ABSTRACT

A quick-release weight used on a fishing line defined as having an overall specific gravity greater than one. The new invention is releasably attached without the need of tools and without the need of knotting the device into the fishing line to provide any desirable spacing between the lure or bait and weight. The device releasably attaches when fishing line is placed between its wire arm and cap, biased toward each other by a compression spring. When a fish strikes, the line can be retrieved to the quick-release weight for instant removal, allowing the remaining line and fish to be retrieved without interference.

In addition, fisherman will appreciate this new invention's integration of weight and quick-release functions into a single device, eliminating the cumbersome task that require fisherman to assemble varying weight sizes to a line release to achieve desired weight combinations.

The patent applicant for this embodiment, a Quick Release Fishing Weight, is John R. Lindeman, 3306 N. 53^{rd} St., Milwaukee, Wis. 53216 U.S.A.

### CROSS-REFERENCE TO RELATED APPLICATIONS

| | | |
|---|---|---|
| 3,293,792 | Dec. 27, 1966 | Bittaker, Jr. |
| 4,279,092 | Jul. 21, 1981 | Hutson |
| 4,698,933 | Oct. 13, 1987 | Shaw |
| 5,027,545 | Jul. 2, 1991 | Lowrie, et al |
| 6,684,558 | Feb. 3, 2004 | Gillespie |
| 7,475,510 | Jan. 13, 2009 | Franklin |

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not applicable

### BACKGROUND OF THE INVENTION

1. Field of Invention

This invention relates to the field of fishing accessories. Specifically, quick-release fishing devices of the type used in maintaining a depth of a lure or bait attached to a fishing line during a trolling or drifting method of presenting a lure or bait by a fisher experienced in the art of fishing.

It is well known that those skilled in the art of fishing submerge the fishing lure or bait in the water on a fishing line in an attempt to catch fish. A variety of means have been used, with varying success, to attach weighted devices to the fishing line to reach a desired depth.

One such device is a downrigger. The use of an external downrigger system requires the purchase and installation of expensive equipment, as shown in Gillespie, U.S. Pat. No. 6,684,558. Another type of device are weights that are crimped or squeezed to fishing line. Crimping sinkers to fishing line require a tool and those weights have a limited lifespan as shown in Bittaker, U.S. Pat. No. 3,293,792. Many other weights of differing configurations must be tied or knotted to fishing tine and said knots are time consuming to complete and are relatively difficult to tie as shown in Lowrie, U.S. Pat. No. 5,027,545. These devices are releasable attached, but suffer limitations with respect to quick release advantages for fisherman. Also, fishers using knots must cut fishing line when it is desired to change size or remove the device from the fishing line.

The following devices relate, with limitations, to this new invention.

The present embodiment allows easy one-handed installation by the fisher, eliminating potential hazards associated with cumbersome releases requiring two hands, such as in the case of Hutson, U.S. Pat. No. 4,279,092. To disengage U.S. Pat. No. 4,279,092 from the fishing line, two hands, or a fishing partner is needed, because attaching the device requires fishing line threaded Into an axial slot, then wrapped around weight and through axial slot one or more times. To release the weight, it must be unwrapped by reversing the attachment process. Using Hutson's device takes two hands: one to hold the weight; and one to unwrap the fish line. Furthermore, these limiting manipulation requirements are amplified when the fisher would attempt to remove this weight while a fish is on the line. These weight release requirements are cumbersome at best, and will likely result in a lost fish.

Similar limitations are present in Franklin, U.S. Pat. No. 7,475,510, which requires the fishing line to be meticulously weaved into angled slots within the weight to attach the device.

The new invention overcomes Franklin's limitations that require looping, threading and other manipulations. In addition, the new invention allows the fisher, while in the process of catching a fish, to instantly release the quick-release weight from the fishing line with one hand. The new invention allows a fisher to select a stationary position for the device on the fishing line, well away from the lure or bait presented. When a fish strikes the lure or bait, the new invention allows a fisher to retrieve the fishing line to the point the device is attached, instantly remove it with one hand, and then continue to retrieve the fishing line into the reel until the fish is close enough to land in the conventional manner.

Another desirable embodiment of this new invention relates to the ease of attaching the device and its fail-safe attachment method. Other attachment devices employ opposing pads that must be carefully loaded to ensure a secure grip of the fishing line as shown by Shaw, U.S. Pat. No. 4,698,933. U.S. Pat. No. 4,698,933 has tried to increase its line-retention qualities by creating a peg that protrudes from one of the two opposing pads. However, that peg does not eliminate the fishing line from potentially passing completely through devices opposing pads, resulting in attachment failure. That difficult attachment method becomes more evident during normal fishing conditions including rough water, cold hands, poor eyesight, low-light or nighttime fishing excursions.

To overcome the attachment problems of Shaw U.S. Pat. No. 4,698,933, this new invention allows the fisher to feed fishing line into a line retention gap. The gap is opened by compressing opposite ends of the device together between thumb and forefinger. The devices gripping arm and cap create a three-sided gap to trap fishing line while attaching the weight. The line is simply inserted horizontally to the caps surface on the open side of the gap created and the fisher releases the compressed ends of the device to complete the attachment. Although not needed, the fisher can achieve even greater gripping power by double-wrapping the fishing line around the gripping arm before closing the gap between gripping arm and cap. Even when double wrapped, this new invention still retains its instant one-handed release capabilities.

The limitations of the Shaw device are amplified further when it is understood that that device was initially designed as a line release device used in conjunction with downriggers. Shaw's quick-release weights require the fisher to assemble a weight to its line-release device. To clarify, in its discussion of prior art, the fisher must first: attach the line-release device to the fishing line and second: attach the desired weight to the line release. This cumbersome assembly process is required each time a fisher desires to change a weight size as fishing conditions change.

Shaw's required assembly limitations have been overcome by this new invention. Fisherman will appreciate the new invention's integration of weight and line release functions, because it has combined them into a single device. This integration eliminates the cumbersome task of assembling varying weights to a line release to achieve desired weight combinations as is required by Shaw's device. This new invention provides a complete quick-release weight of a desired size. During the manufacturing process, this invention is created to the complete weight/size a fisher desires (i.e. ¼ ounce, ¾ ounce, 1½ ounce, ect.).

The difficulties associated with prior art has been addressed and overcome by this present invention. The present invention overcomes the need for expensive and cumbersome gear, as in the case of downrigger systems. This new invention eliminates difficult manipulation of line and weight while attaching the device to fishing line by creating a user-friendly, one-handed attachment method. In addition this new invention provides a fail-safe attachment method. Most importantly, this new invention has the ability to instantly attach and release from fishing line whenever desired by the fisher.

Those skilled in the art of fishing will understand fully how the capabilities of this new invention will enhance the overall fishing experience. This device will provide: improved quick-release weight performance; quick and easy weight changes; eliminated assembly requirements; and a low-cost alternative to expensive downrigger equipment.

### BRIEF SUMMARY OF THE INVENTION

With the foregoing in mind, the intended object of the present invention is to provide those skilled in the art of fishing a quick-release fishing weight that is releasably attached to fishing line.

A correlated object of the invention is to provide a quick-release fishing weight that is inexpensive to manufacture in any desired weight configuration.

Another object of the invention is to permit use of a quick-release fishing weight that will not move along the fishing line or require the tying of knots or crimping the weight to fishing line.

A further object of the invention is to provide a quick-release weight which is relatively inexpensive to purchase, and can be reused indefinitely without damaging weight or fishing line.

Another object of the invention is to enable the fisherman to attach the quick-release weight using a greater distance between lure or bait and weight to compensate for wary fish.

Still another object of the invention is to provide a quick-release weight that permits the fisherman to retrieve fishing line up to the attached quick-release weight, instantly remove it with one hand, then continue to retrieve the fishing line and fish to be landed in the conventional manner.

One more object of the invention is to provide a quick-release weight suitable for use with a number of different weight lines without the use of tools or special attachment procedures.

A further object of the invention is to provide a user-friendly quick-release weight that will not require a high degree of manual dexterity for attachment to and removal from fishing line.

Still another object of the invention is to provide a fail-safe method of attaching the weight.

Other objects and advantages will become apparent to those skilled in the art upon reading the descriptions of the invention and upon reference to the drawings.

In the practice of the invention, is a quick-release fishing weight having a fish line engaging rubber-coated cap and wire gripping arm biased toward each other to a dosed position by a spring. The fish line engaging members releasably retain a fish line and assure proper alignment of the fish line when “loading” the line into the quick-release weight. The rubberized coating of the cap is bonded into position by its inherent properties and a specialized primer applied during the manufacturing process. The wire gripping arm is set into the main body of the weight during the manufacturing process.

The quick-release fishing weight, with a specific gravity greater than one, is formed when a wire is extended from within the weights main body. The extended wire first passes through a compression spring to hold said spring in place atop the main body of the weight. The extended wire is then threaded through a rubber-coated cap that will house the compression spring. With the compression spring under load, between the main body and inside the cap, the extended wire is bent at a 90 degree angle to hold said cap in place under the load force of the spring. The spring has a bias outward toward the bent wire.

The line engaging, resilient rubber coating on the cap is held in position in two manners: First, the inherent properties of its chemical composition; and second, a primer that improves the adhesion of the rubber coating to the cap. The synthetic rubber coating is easily applied by repeated dipping to obtain a desired thickness. The rubber coating then shrinks while air-drying to tightly conform and adhere to the surface of the cap. Secondly, first applying an acrylic primer to the surface of the cap improves adhesion between said surfaces.

The line engaging wire gripping arm, on one end, is embedded into the heavy metal main body of the quick-release weight. The embedded portion of the wire is slightly bent to permanently set itself inside the main body of the weight. The opposite portion of the wire arm is extended from the top end of the main body with length enough to receive previously described components of the quick-release weight.

A spring, housed within the rubber-coated cap, is held under compression by said cap and bent gripping wire. The loaded spring's force now has a bias outward toward the bent gripping wire, providing sufficient force to releasably retain an engaged fish line. The corrosion resistant spring is held in a loaded position sufficient to maintain its force qualities.

With one hand and minimal manual dexterity, a fish line is engaged into the unit by compressing opposite ends of the new invention toward each other between thumb and forefingers. This compression creates a gap between the top of the rubber-coated cap and the underside of the wire gripping arm. The portion of the gripping arm horizontal to the surface of the cap acts to guide the fish line into the “armpit” of the gripping arm. The “armpit” is formed when said gripping arm is bent 90 degrees. With the fish line placed in the “armpit” of the gripping arm, the invention is released and the fish line is releasably retained instantly. To release fish line from the new invention, compress opposite ends of the quick-release weight between thumb and forefingers and the fish line instantly releases.

An additional function of the gripping arm provides a fail-safe method to load fish line into the quick-release weight. To attach the invention to a fishing line, the fisher creates a gap by compressing the device at opposite ends between thumb and forefinger. Fishing line is fed into the gap, horizontal to the cap. The created gap is three-sided, comprising of the cap's top, and the two sides of the gripping arm, formed as it was bent at 90 degrees after extending through the cap. The gripping arm acts to guide the fish line into alignment between the rubberized cap and into the gripping arm's “armpit”.

The “armpit” automatically traps the fish line while being loaded without specific attention needed from the fisher. Those familiar with the art of fishing will appreciate the fail-safe line retaining qualities of the new invention with knowledge of adverse fishing conditions such as rough water, low light, poor eyesight, cold hands, ect.

Those skilled in the art of fishing will understand and appreciate the embodiments of the present invention described and shown in the following drawings:

### BRIEF DESCRIPTION OF THE DRAWINGS

FIG. 1 is a front view of one embodiment of the quick-release device of the present invention;

FIG. 2 is a perspective view of the line quick-release device shown in FIG. 1 engaged to a fishing line;

FIG. 3 is a cross, sectional view of the quick-release device shown in FIG. 1 engaged to a fishing line;

FIG. 4 is a perspective view of the quick-release device shown in FIG. 1 under compression and poised to engage a fishing line;

### DETAILED DESCRIPTION OF THE DRAWINGS

### Drawings Reference Numerals

1 Main Body; 2 Cap; 3 Rubberized Coating; 4 Wire Gripping Arm; 5 Fishing Line; 6 Compression Spring; 7 Gap created to receive Fishing Line; 8 Quick-release Device; 9 small hole.

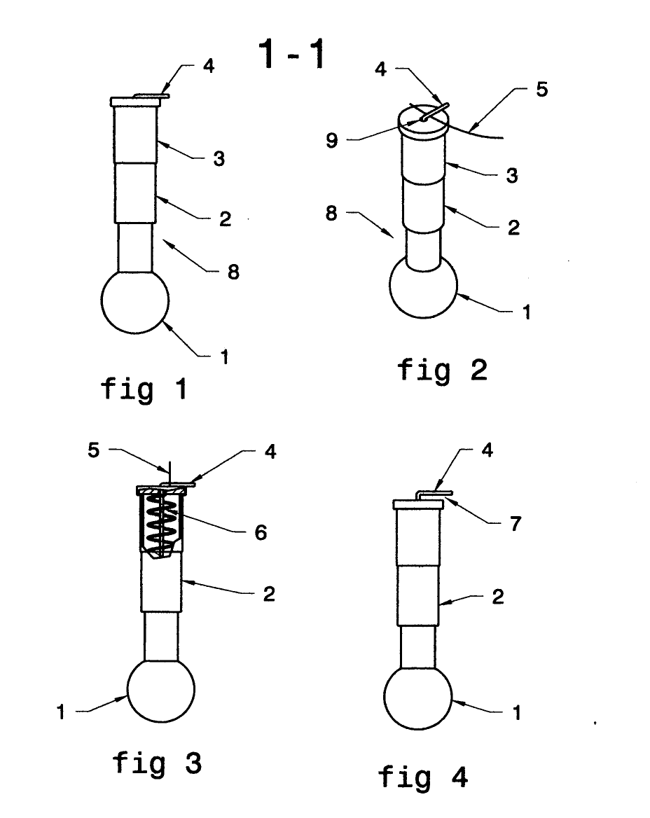

Referring first to FIG. 1, there is shown the quick-release weight 8 of the present invention with main body 1, a cap 2, covering the top end of the main body 1. The cap 2 has a rubberized covering 3. A wire gripping arm 4 that is bent horizontal (90 degrees) to the top of the cap 2.

FIG. 2 represents a side perspective view of the quick-release weight 8 to show the fishing line 5 releasably retained between the wire gripping arm 4 and the cap's 2 top. FIG. 2 also shows the rubberized coating 3 on the cap 2 that adds additional fishing line retention properties. Also shown in FIG. 2 is the small hole 9 by which the wire gripping arm 4 passes through as it extends from the quick-release's 8 main body 1.

FIG. 3 is a cross sectional view showing the present embodiment engaged to a fishing line 5 between the wire gripping arm 4 and cap 2. In addition, the embodiments cap 2 houses a compression spring 6, which is held inside the cap 2 in a compressed position between the cap 2 and the devices main body 1. The compression spring 6 is biased outward in the cap 2. The fishing line 5 is retained between the wire gripping arm 4 and the cap 2 by the biased force supplied by the compression spring 6.

FIG. 3 clearly shows how the cap 2, wire gripping arm 4 and biased force from the compression spring 6 work in conjunction and restrict the present invention from moving from the designated and desired position on a fishing line 5 as decided by the fisherman. The compression spring 6 provides enough force to retain the fishing line 5 in the desired position and is still easily compressible by the fisher to attach or release the embodiment instantly.

FIG. 4 is a side perspective view showing the present embodiment in a compressed state to clearly show the gap 7 created to releasably attach the embodiment to a desired position. A fisher can create the gap 7 between the wire gripping arm 4 and cap 2 by compressing the top of the embodiments cap 2 and bottom of the main body 1 together between thumb and forefingers. The present embodiment is affixed quickly and also removed from a fishers desired location by creating said gap 7.

Those skilled in the art will appreciate that the present invention may attach to a fishing line, such that once attached to the line, the line restricting members reduce the ability of the embodiment to slip from a desired position. It will also be appreciated that the present invention requires minimal manual dexterity and can easily be deployed with one hand, requiring no wrapping, threading or special positioning of the fishing line as the prior art embodiments require. Also, the features of this present invention effectively grasp fishing line without requiring stretching, twisting or other repositioning of embodiment parts as required by less effective prior art embodiments. This device allows fishers to present any lure/bait easily, effectively and economically without the need of extensive and expensive external apparatus or cumbersome embodiment manipulation.

It has been observed and experienced that a greater length of distance between the lure or bait and the weight positively influences presentation and fishing success. Though longer distances often increase catch rates for various reasons, fisherman are limited to shorter distances when using weighted fishing lines due to the use restrictions of traditional knotted or crimped weights. The major restriction, but not limited to, is that the design bulk of a traditional weights cannot be reeled with the line through the fishing pole's line guides and into the fishing reel. Therefore, when a fish is caught, traditional weights must be near the lure or bait in order to retrieve enough line to bring the fish close enough to be netted. This new device offers fisherman a solution to the limitations of traditional weights with its quick-release qualities, including, but not limited to, weight location placement and ability to offer improved catch rates. In addition, this device enables fisherman to easily change between various weight sizes without additional assembly or knot-tying requirements to match continually changing fishing conditions with ease.

Without limitation, the main body may have any suitable shape, and may be molded of metallic material to achieve said shape. The density of the material and size of the member may be selected to create a desired weight. For example, without limitation, weights may be created in the varying sizes including ¼ ounce, 3/16 ounce, 1.5 ounce, etc.

This invention has been described herein in considerable detail in order to comply with the patent statutes and to provide those skilled in the art with the information needed to apply the novel principles and to construct and use such specialized components as are required. However, it is to be understood that the invention can be carried out by specifically different equipment and devices, and that various modifications, both as to the equipment and operating procedures, can be accomplished without departing from the scope of the invention itself.

1. An improved quick-release fishing weight comprising a main body, with a specific gravity greater than one, which is formed with a wire extending from end of said weight that passes through a compression spring, held in place on the extended wire, between the weight and a housing cap, which when the compression spring under load between weight and housing cap, the extended wire is bent at 90 degrees to hold said cap in place as the load force of the spring pushes cap outward into bent extended wire creating one unit by incorporating weight body with spring, housing cap and extended bent wire;

2. The quick-release fishing weight as defined in claim 1, wherein means the device can be releasably attached at any desired point along fish line between lure or bait and fishing pole;

3. The quick-release fishing weight defined in claim 1, wherein the unit is capable of being applied to fishing line is intended to be retained by the fisher for unlimited applications to the fishing line;

4. The quick-release fishing weight as defined in claim 1, wherein said device is generally made from common lead, but can be formed by many materials readily available;

5. The quick-release fishing weight's as defined in claim 1, wherein a rubberized finish is applied to the said cap that provides a protective surface that ensures the fishing line maintains its structural integrity;

6. The quick-release fishing weight's rubberized cap as defined in claim 5, wherein the said rubberized cap provides a surface that increases line retention qualities that secures device to the fishing line, restricting the devices movement along fishing line;

7. The quick-release fishing weight's rubberized cap as defined in claim 5, wherein the device's cap will work similarly with many styles of fishing weights and is not intended to be limited to only the quick-release weight described herein;
